(19) United States
(12) Patent Application Publication
(10) Pub. No.: US 2009/0232664 A1
(43) Pub. Date: Sep. 17, 2009

(54) Permanent magnet motor for subsea pump drive

(75) Inventors: Ronghai Qu, Clifton Park, NY (US); Vasanth Kumar Srinivasa Kothnur, Clifton Park, NY (US); Xianghui Huang, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric, Schenectady, NY (US)

(21) Appl. No.: 12/075,664

(22) Filed: Mar. 12, 2008

(51) Int. Cl. F04B 49/00; H02K 9/00; F04B 17/03

(52) U.S. Cl. 417/44.1; 310/54; 310/48; 417/366

(57) ABSTRACT

A subsea pump drive employs a permanent magnet (PM) motor to drive a subsea pump. The PM motor rotor in one embodiment is canned with a non-magnetic material such as inconel that can provide a desired level of corrosion protection. The PM motor provides a subsea pump drive that is smaller and more efficient, having a high power factor than a subsea pump drive utilizing a conventional induction motor. The PM motor subsea pump drive eliminates the necessity for a topside storage tank and associated fluid transfer lines when the motor rotor is cooled with processed fluid.

### BACKGROUND

The invention relates generally to subsea pumping systems and methods, and more specifically a canned permanent magnet motor for a subsea pump drive.

The need for subsea pumps in the oil and gas industry has been increasing due to increasing energy requirements, and because onshore energy sources are becoming more scarce. These industries must now look for energy sources offshore; and the distance between shore and subsea fields continues to increase.

Electrical motors have been selected as a standard to drive the subsea pumps due to ease of power transfer over long distances when compared to other drive systems and methods, including, for example, hydraulic driven pumps. Conventional systems and methods employ induction motors for driving the aforesaid subsea pumps. Use of induction type motors has been problematic however, since induction motors are low efficiency and low power factor motors. This low efficiency and low power factor undesirably require an oversized umbilical connection and variable frequency converter on the topside in order to provide a large amount of VAR power to the subsea motor. Both, the oversized umbilical connection and variable frequency converter undesirably increase the cost to the subsea pumping system.

It would be both advantageous and beneficial to provide a subsea pumping system that overcomes the problems generally associated with subsea pumping systems that employ induction motors. The subsea pumping system should have an overall efficiency that is greater than known subsea pumping systems utilizing induction motors, such that the subsea pumping system could function using a low power rating umbilical. It would be further advantageous if the subsea pumping system had a higher power factor than known subsea pumping systems utilizing induction motors, such that the subsea pumping system could function using a low power rating topside variable frequency converter.

### BRIEF DESCRIPTION

Briefly, in accordance with one embodiment, a subsea pump drive motor comprises a stator, a rotor comprising a plurality of permanent magnet pole pieces, and a non-magnetic can configured to affix the pole pieces to the rotor.

According to another embodiment, a subsea pump drive system comprises a permanent magnet subsea pump drive motor having a rotor configured with a plurality of permanent magnet pole pieces, the rotor and plurality of pole pieces disposed within a non-magnetic can configured to prevent corrosion of the rotor and plurality of pole pieces.

According to yet another embodiment, a method of controlling a subsea pump comprises:

providing a permanent magnet (PM) subsea pump drive motor; and

controlling the PM drive motor such that the PM drive motor drives a subsea pump in response to variable frequency converter signals received by the PM drive motor.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a permanent magnet motor subsea pump drive according to one embodiment of the invention;

FIG. 2 illustrates the permanent magnet motor subsea pump drive depicted in FIG. 1, but that does not have a wireless transmitter such as depicted in FIG. 1;

FIG. 3 illustrates in more detail, the rotor portion of the permanent magnet motor depicted in FIGS. 1 and 2, according to one embodiment;

FIG. 4 is a cross-sectional view of the permanent magnet motor depicted in FIGS. 1 and 2, according to one embodiment;

FIG. 5 illustrates a permanent magnet motor subsea pump drive according to another embodiment of the invention; and

FIG. 6 the permanent magnet motor subsea pump drive depicted in FIG. 5, but that does not have a wireless transmitter such as depicted in FIG. 5.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

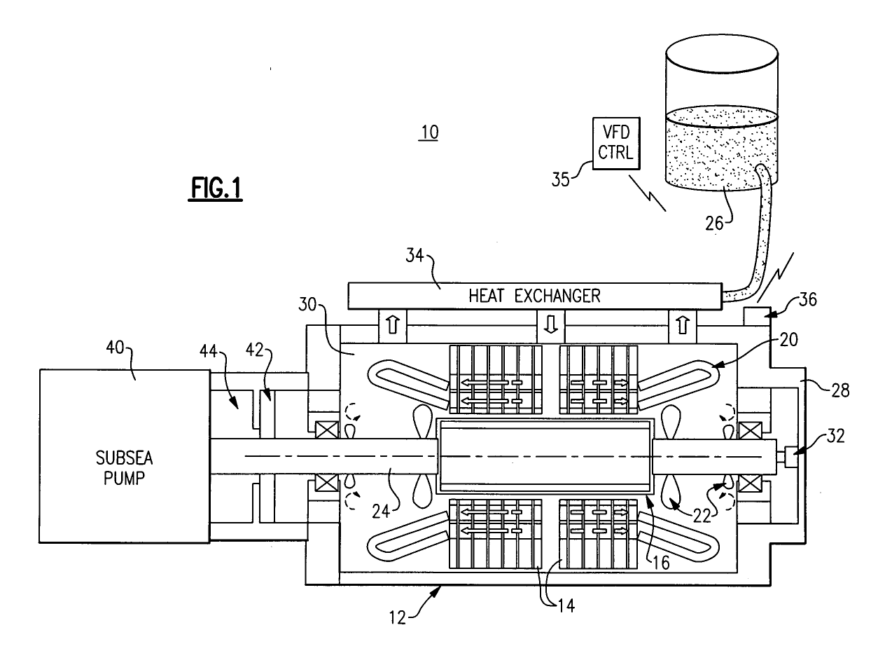

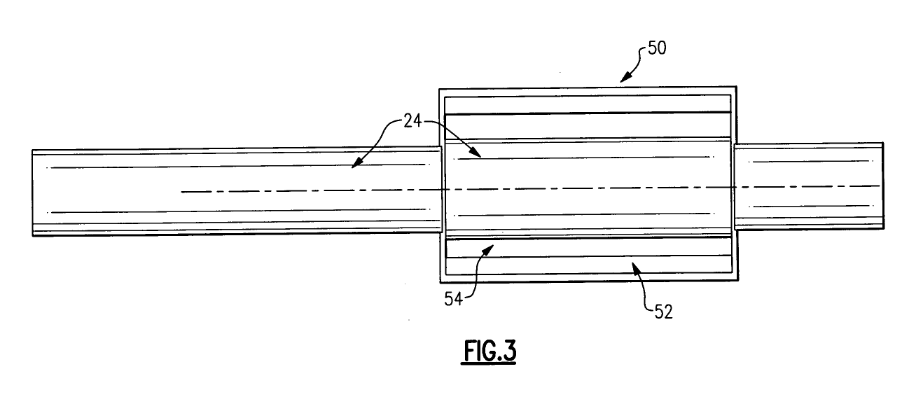

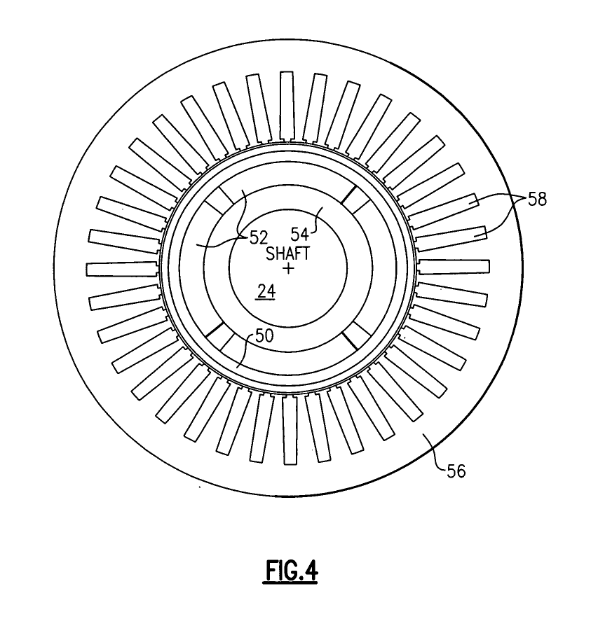

FIG. 1 illustrates a permanent magnet motor subsea pump drive 10 according to one embodiment of the invention. Subsea pump drive 10 includes a permanent magnet motor 12 comprising a stator 14 and a rotor 16. Windings 20 are disposed in stator slots. The rotor 16 comprises a plurality of permanent magnet (PM) poles described herein below with reference to FIGS. 3 and 4. The rotor 16 also includes a non-magnetic can configured to fix the permanent magnets to the rotor 16, also described further herein below with reference to FIG. 3.

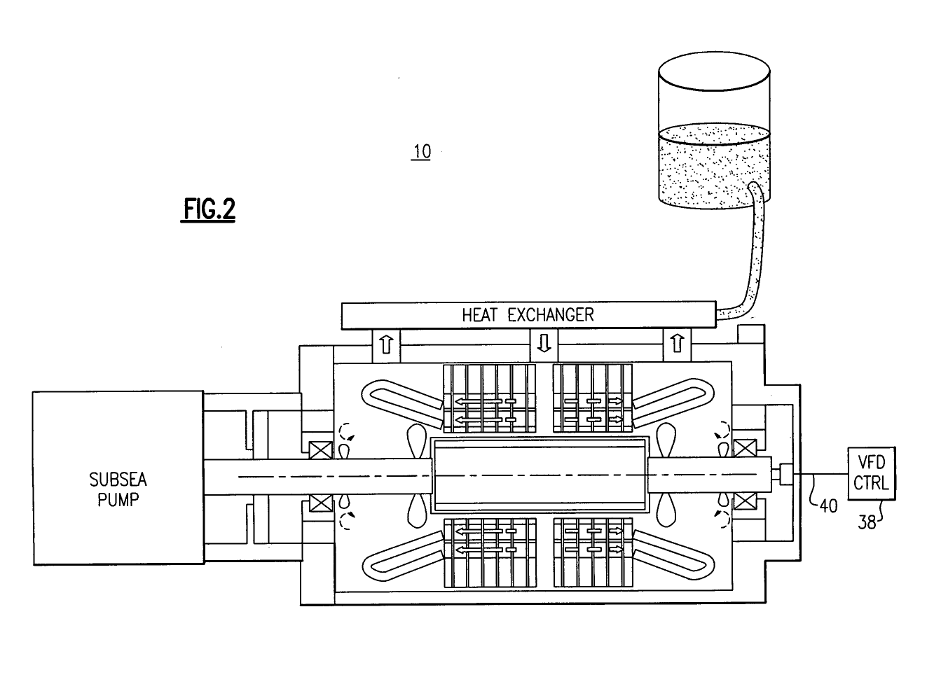

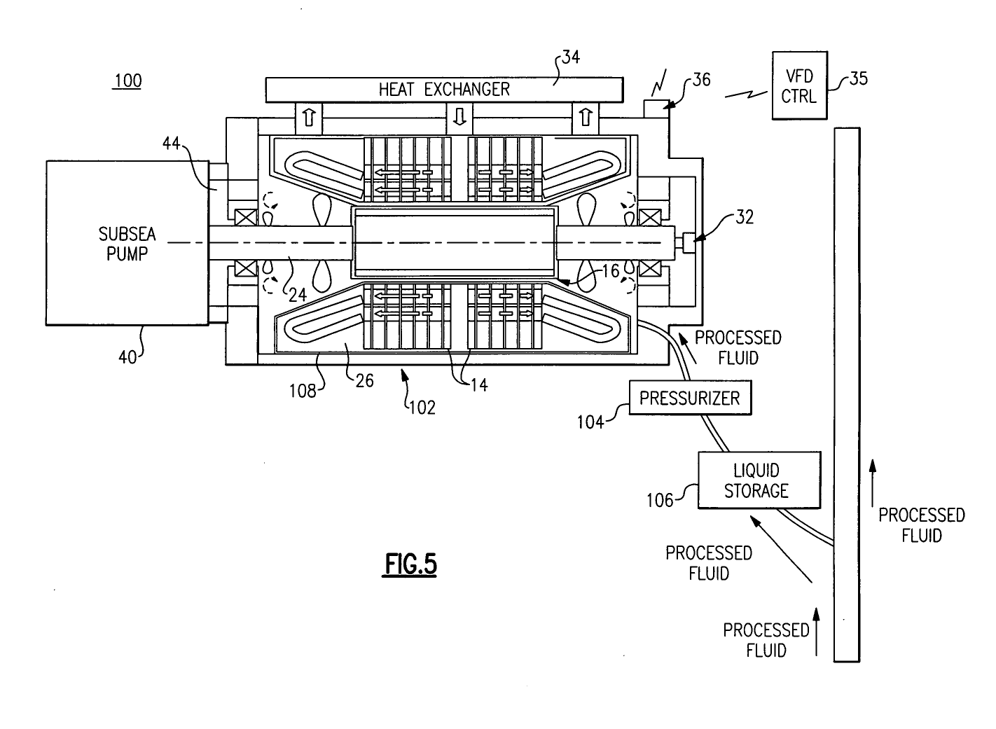

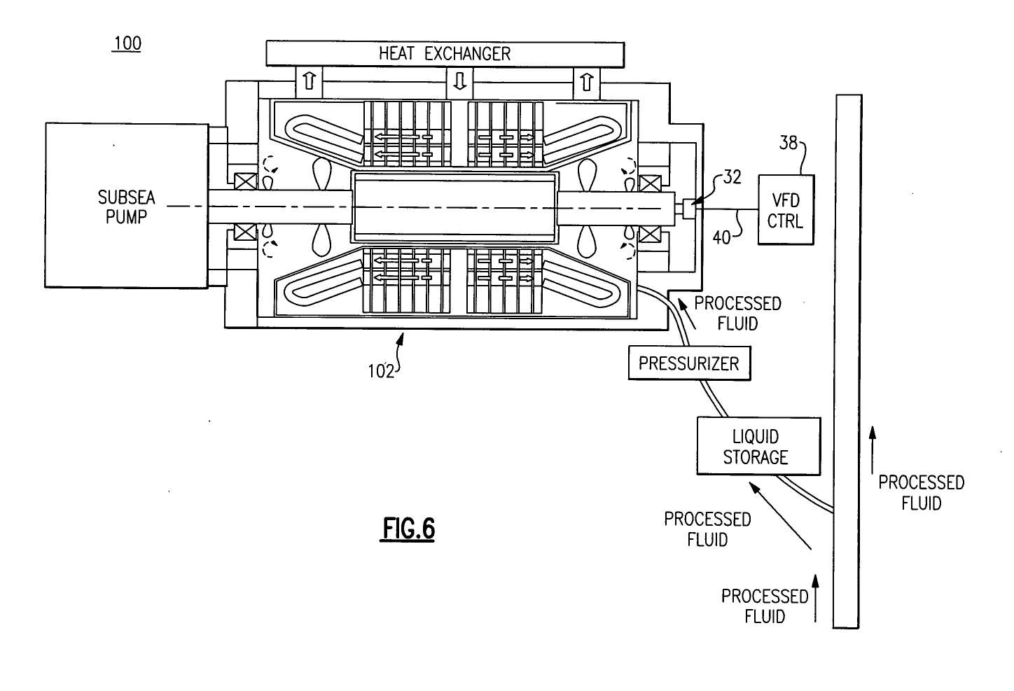

Four sets of blades 22 are disposed on the rotor shaft 24. These blades 22 are configured to pump cooling fluid 26 flowing through a motor sealing can 28 that encapsulates both the stator 14 and the rotor 16 according to one aspect of the invention illustrated in FIGS. 5 and 6, where both the stator 14 and the rotor 16 are canned for corrosion protection when processed fluid is used for cooling. The cooling fluid 26 works to provide cooling of the stator 14, rotor 16, and the associated bearings. In another embodiment illustrated in FIGS. 1 and 2, the stator 14 is not canned, and the machine cavity 30 is filled with a clean cooling fluid having a suitable thermal conductivity while also possessing workable electrical insulation characteristics. A heat exchanger 34 operates to transfer heat from the motor 12 to outside seawater.

A rotor 16 position signal generated via an encoder 32 is transferred to a variable frequency converter (VFD) 35 via a wireless signal transmitter 36 according to one embodiment. In another embodiment depicted in FIG. 2, the rotor position signal is transferred to a VFD via a suitable communication cable (40).

The encoder 32 is connected to one end of rotor shaft 24 to detector rotor position for proper speed/torque control of the permanent magnet motor 12. Traditional control approaches utilizing communication cables are difficult to employ when the VFD 35 is far away from the motor 12 due to signal attenuation along cables between the motor 12 and the VFD 35. Further, traditional sensorless control approaches also face challenges due to difficulties associated with accurate measurement of motor terminal voltages through such long distances.

The foregoing challenges associated with traditional control approaches utilizing communication cables are overcome using a wireless signal transmitter 36, discussed herein above. The rotor position signals are sent to the wireless signal transmitter 36, which then transmits the rotor position signals to a topside controller/VFD 35 that is used to drive the PM motor 12.

FIG. 2 illustrates the permanent magnet motor subsea pump drive depicted in FIG. 1, but that does not have a wireless transmitter such as depicted in FIG. 1. The rotor position signal is transferred through suitable communication wires 40. This topology is especially useful when a long cable is not required, i.e. a subsea VFD 38 is employed and is located in close proximity to the PM motor 12.

The end of the rotor shaft 24 opposite the end connected to the encoder 32 is connected to a subsea pump 40, such as a multiphase pump. There is a seal 42 between the motor 12 and pump 40 to block motor cooling fluid 26 from flowing into the pump 40. The fluid pressure inside the motor 12 is normally maintained higher than the fluid pressure inside the pump 40 via a pressurizer typically located subsea beside the motor 12, such as described below with reference to FIGS. 5 and 6, to prevent any processed fluid 44 flowing into the motor side from the pump side. Any motor cooling fluid leakage that may pass from the motor side into the pump side that occurs during motor-pump set rotation is replenished via a topside fluid tank 46 that is connected to the subsea motor 12 through an umbilical supply line 48 to provide cooling fluid as needed.

FIG. 3 illustrates in more detail, the rotor 16 portion of the permanent magnet motor 12 depicted in FIGS. 1 and 2, according to one embodiment. A nonmagnetic can 50 that is constructed from a suitable nonmagnetic material such as, without limitation, inconel or aluminum, is configured to attach a plurality of magnets 52 to the rotor core or back iron portion 54 of the rotor 16, and to protect each magnet from corrosion. The back iron portion 54 is constructed from a suitable ferromagnetic material.

FIG. 4 is a cross-sectional view of the permanent magnet motor 12 depicted in FIGS. 1 and 2, according to one embodiment. One portion of the motor shaft 24 is encapsulated via the rotor core 54. The permanent magnets 52 having north and south poles, are attached to the rotor core 54 via the rotor can 50. Stator laminations 56 having slots 58 surround the rotor can 50.

FIG. 5 illustrates a permanent magnet motor subsea pump drive 100 according to another embodiment of the invention. Pump drive 100 includes a permanent magnet motor 102 that is cooled using the fluid 44 processed by the subsea pump 40. Subsea pump drive 100 does not require a topside storage tank or associated umbilical cooling fluid supply line such as employed by pump drive 10 described above with reference to FIGS. 1 and 2.

A pressurizer 104 is employed to maintain a positive pressure from the motor 12 to the subsea pump 40 under all conditions. An optional liquid storage tank 106 can be used to store processed fluid 44 for motor cooling purposes when the processed fluid is purely gas.

The stator 14 is also encapsulated via a can 108 to prevent any process fluid 44 or gas from entering the stator 14 portion of the permanent magnet motor 102. This stator can 108 is filled with a clean cooling fluid 26, such as a suitable oil, to cool the stator 14. A heat exchanger 34 can be employed to exchange heat from the motor 102 to outside seawater.

Subsea pump drive 100 also employs an encoder 32 that is connected to one end of rotor shaft 24 to detector rotor position for proper speed/torque control of the permanent magnet motor 102. A rotor 16 position signal generated via the encoder 32 is transferred to a variable frequency converter (VFD) 35 via a wireless signal transmitter 36 according to one embodiment. In another embodiment depicted in FIG. 6, the rotor position signal is transferred to a VFD 38 via a suitable communication cable (40) and does not have a wireless transmitter such as depicted in FIG. 5.

In summary explanation, a subsea pump drive employs a permanent magnet (PM) motor to drive a subsea pump. The PM motor rotor in one embodiment is canned with a non-magnetic material such as inconel, that can provide a desired level of corrosion protection. The PM motor provides a subsea pump drive that is smaller and more efficient, having a high power factor than a subsea pump drive utilizing a conventional induction motor. The PM motor subsea pump drive eliminates the necessity for a topside storage tank and associated fluid transfer lines when the motor rotor is cooled with processed fluid.

The PM subsea pump drive motor achieves its high efficiency due to the permanent magnetic flux on the rotor linking the stator so that the PM motor can achieve higher efficiency due to absence of rotor current.

The PM subsea pump drive motor further has an increased power factor due to the absence of exciting current.

The PM subsea pump drive motor employs lower power umbilical features due to the aforesaid high power factor and high motor efficiency.

The PM subsea pump drive motor employs a lower power topside variable frequency converter due to the aforesaid high power factor and high motor efficiency.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A subsea pump drive motor comprising:
a stator;
a rotor comprising a plurality of permanent magnet pole pieces; and
a non-magnetic can configured to affix the pole pieces to the rotor.

2. The subsea pump drive motor according to claim 1, further comprising a stator can enveloping the stator and configured to receive a stator cooling fluid.

3. The subsea pump drive motor according to claim 2, further comprising a heat exchanger configured to transfer heat from the stator cooling fluid to seawater surrounding the pump drive motor.

4. The subsea pump drive motor according to claim 1, wherein the motor is configured to be cooled via a fluid processed via a subsea pump.

5. The subsea pump drive motor according to claim 1, wherein motor is configured to be cooled via a desired cooling fluid having desired thermal transfer and electrical insulation characteristics.

6. The subsea pump drive motor according to claim 5, further comprising a heat exchanger configured to transfer heat from the motor cooling fluid to seawater surrounding the pump drive motor.

7. The subsea pump drive motor according to claim 1, further comprising a rotor shaft seal configured to prevent motor cooling fluid from exiting the subsea pump drive motor.

8. The subsea pump drive motor according to claim 1, further comprising an encoder affixed to one end of the rotor shaft to detect the position of the rotor.

9. The subsea pump drive motor according to claim 8, further comprising a wireless signal transmitter configured to receive rotor position signals generated via the encoder and transmit the signals to a desired variable frequency converter controller.

10. A subsea pump drive system comprising a permanent magnet (PM) subsea pump drive motor having a rotor configured with a plurality of permanent magnet pole pieces, the rotor and plurality of pole pieces disposed within a non-magnetic can configured to prevent corrosion of the rotor and plurality of pole pieces.

11. The subsea pump drive system according to claim 10, wherein the PM drive motor further comprises a stator can enveloping the stator and configured to receive a stator cooling fluid.

12. The subsea pump drive system according to claim 11, further comprising a heat exchanger configured to transfer heat from the stator cooling fluid to seawater surrounding the PM pump drive motor.

13. The subsea pump drive system according to claim 10, wherein the PM motor is further configured to be cooled via a fluid processed via a subsea pump.

14. The subsea pump drive system according to claim 10, wherein the PM motor is further configured to be cooled via a cooling fluid having desired thermal transfer and electrical insulation characteristics.

15. The subsea pump drive system according to claim 14, further comprising a heat exchanger configured to transfer heat from the motor cooling fluid to seawater surrounding the PM pump drive motor.

16. The subsea pump drive system according to claim 10, further comprising a rotor shaft seal configured to prevent PM motor cooling fluid from exiting the subsea pump drive PM motor.

17. The subsea pump drive system according to claim 10, further comprising an encoder affixed to one end of the rotor shaft to detect the position of the rotor.

18. The subsea pump drive system according to claim 17, further comprising a wireless signal transmitter configured to receive rotor position signals generated via the encoder and transmit the signals to a desired variable frequency converter controller.

19. A method of controlling a subsea pump, the method comprising:
providing a permanent magnet (PM) subsea pump drive motor; and
driving a subsea pump via the PM drive motor.

20. The method according to claim 19, wherein providing a PM subsea pump drive motor comprises providing an encoder affixed to one end of the PM subsea pump drive motor rotor shaft to detect the position of the PM motor rotor.

21. The method according to claim 20, further comprising:
providing a wireless signal transmitter configured to receive rotor position signals generated via the encoder and transmit the signals to a desired variable frequency converter controller; and
controlling speed and torque characteristics of the PM motor in response to the rotor position signals generated via the encoder.

22. The method according to claim 19, wherein providing a PM subsea pump drive motor comprises providing a rotor configured with a plurality of permanent magnet pole pieces, the rotor and plurality of pole pieces disposed within a non-magnetic can configured to prevent corrosion of the rotor and plurality of pole pieces.

23. The method according to claim 22, wherein providing a PM subsea pump drive motor further comprises providing a stator and a stator can enveloping the stator and configured to receive a stator cooling fluid.

24. The method according to claim 23, further comprising:
providing a heat exchanger; and
transferring heat from the stator cooling fluid to the seawater surrounding the pump drive motor via the heat exchanger.

25. The method according to claim 19, further comprising cooling the PM drive motor via a fluid processed via the subsea pump while the PM drive motor is driving the subsea pump.
